(19) United States
(12) Patent Application Publication
(10) Pub. No.: US 2009/0125411 A1
(43) Pub. Date: May 14, 2009

(54) Wireless communications device configured to order out of stock items

(76) Inventors: Jonathan Otto, Palm Beach, FL (US); Michael R. Mueller, San Francisco, CA (US); Andrew Van Luchene, Santa Fe, NM (US)

Correspondence Address: SIMPSON & SIMPSON, PLLC, 5555 MAIN STREET, WILLIAMSVILLE, NY, 14221-5406, US

(21) Appl. No.: 11/983,654

(22) Filed: Nov. 9, 2007

(51) Int. Cl. G06Q 30/00; G06Q 99/00; G06Q 20/00

(52) U.S. Cl. 705/26; 705/1

(57) ABSTRACT

A method for querying an end user, including the steps of generating, in a processor of a specially programmed general-purpose computer, a query as to whether an item is out of stock at a retail location or missing at the retail location and transmitting the query from an interface element in the general-purpose computer to a communication network for transmission to a wireless communications device located in the retail location. In some aspects, the query includes an option for payment of the order; the method generates an offer regarding an option for gaining possession of the order and transmits the offer to the communication network; or the method determines that the order is available at another retail location, different that the first retail location, generates a notification regarding the availability at the other retail location, and transmitting the notification to the network for transmission to the wireless communications device.

### CROSS-REFERENCE TO RELATED APPLICATIONS

This application is related to: U.S. patent application Ser. No. 09/052,093 entitled “Vending Machine Evaluation Network” and filed Mar. 31, 1998; U.S. patent application Ser. No. 09/083,483 entitled “Method and Apparatus for Selling an Aging Food Product” and filed May 22, 1998; U.S. patent application Ser. No. 09/282,747 entitled “Method and Apparatus for Providing Cross-Benefits Based on a Customer Activity” and filed Mar. 31, 1999; U.S. patent application Ser. No. 08/943,483 entitled “System and Method for Facilitating Acceptance of Conditional Purchase Offers (CPOs)” and filed on Oct. 3, 1997, which is a continuation-in-part of U.S. patent application Ser. No. 08/923,683 entitled “Conditional Purchase Offer (CPO) Management System For Packages” and filed Sep. 4, 1997, which is a continuation-in-part of U.S. patent application Ser. No. 08/889,319 entitled “Conditional Purchase Offer Management System” and filed Jul. 8, 1997, which is a continuation-in-part of U.S. patent application Ser. No. 08/707,660 entitled “Method and Apparatus for a Cryptographically Assisted Commercial Network System Designed to Facilitate Buyer-Driven Conditional Purchase Offers,” filed on Sep. 4, 1996 and issued as U.S. Pat. No. 5,794,207 on Aug. 11, 1998; U.S. patent application Ser. No. 08/920,116 entitled “Method and System for Processing Supplementary Product Sales at a Point-Of-Sale Terminal” and filed Aug. 26, 1997, which is a continuation-in-part of U.S. patent application Ser. No. 08/822,709 entitled “System and Method for Performing Lottery Ticket Transactions Utilizing Point-Of-Sale Terminals” and filed Mar. 21, 1997; U.S. patent application Ser. No. 09/135,179 entitled “Method and Apparatus for Determining Whether a Verbal Message Was Spoken During a Transaction at a Point-Of-Sale Terminal” and filed Aug. 17, 1998; U.S. patent application Ser. No. 09/538,751 entitled “Dynamic Propagation of Promotional Information in a Network of Point-of-Sale Terminals” and filed Mar. 30, 2000; U.S. patent application Ser. No. 09/442,754 entitled “Method and System for Processing Supplementary Product Sales at a Point-of-Sale Terminal” and filed Nov. 12, 1999; U.S. patent application Ser. No. 09/045,386 entitled “Method and Apparatus For Controlling the Performance of a Supplementary Process at a Point-of-Sale Terminal” and filed Mar. 20, 1998; U.S. patent application Ser. No. 09/045,347 entitled “Method and Apparatus for Providing a Supplementary Product Sale at a Point-of-Sale Terminal” and filed Mar. 20, 1998; U.S. patent application Ser. No. 09/083,689 entitled “Method and System for Selling Supplementary Products at a Point-of Sale and filed May 21, 1998; U.S. patent application Ser. No. 09/045,518 entitled “Method and Apparatus for Processing a Supplementary Product Sale at a Point-of-Sale Terminal” and filed Mar. 20, 1998; U.S. patent application Ser. No. 09/076,409 entitled “Method and Apparatus for Generating a Coupon” and filed May 12, 1998; U.S. patent application Ser. No. 09/045,084 entitled “Method and Apparatus for Controlling Offers that are Provided at a Point-of-Sale Terminal” and filed Mar. 20, 1998; U.S. patent application Ser. No. 09/098,240 entitled “System and Method for Applying and Tracking a Conditional Value Coupon for a Retail Establishment” and filed Jun. 16, 1998; U.S. patent application Ser. No. 09/157,837 entitled “Method and Apparatus for Selling an Aging Food Product as a Substitute for an Ordered Product” and filed Sep. 21, 1998, which is a continuation of U.S. patent application Ser. No. 09/083,483 entitled “Method and Apparatus for Selling an Aging Food Product” and filed May 22, 1998; U.S. patent application Ser. No. 09/603,677 entitled “Method and Apparatus for selecting a Supplemental Product to offer for Sale During a Transaction” and filed Jun. 26, 2000; U.S. Pat. No. 6,119,100 entitled “Method and Apparatus for Managing the Sale of Aging Products and filed Oct. 6, 1997 and U.S. Provisional Patent Application Ser. No. 60/239,610 entitled “Methods and Apparatus for Performing Upsells” and filed Oct. 11, 2000.

By “related to” we mean that the present application and the applications noted above are in the same general technological area and have a common inventor or assignee. However, “related to” does not necessarily mean that the present application and any or all of the applications noted above are patentably indistinct, or that the filing date for the present application is within two months of any of the respective filing dates for the applications noted above.

### FIELD OF THE INVENTION

The invention relates generally to methods and systems for using a wireless communications device to order out of stock or missing items while the wireless device is located in a retail location.

### BACKGROUND OF THE INVENTION

Currently, retail sales locations can offer an extremely wide variety of choices to consumers. For example, Wal-Mart, the world's largest retailer, offers literally thousands of items to its customers at any one location. This variety and volume of items provides consumers with a wide number of options, while tending to drive prices lower and lower. Buying and selling at such high volumes has obvious benefits for the retailer as well. However, a major drawback to such variety is the increasing difficulty of consumers in finding the products they are looking for. Unfortunately, many customers, even regular customers, oftentimes leave frustrated that they couldn't find the product(s) they were looking for while in the location. A common reason for customers not finding such product(s), despite the volumes and improved inventory control methods employed by such retailers, is that the product(s) is temporarily out of stock.

It is known to try and address the question of out of stock items through interactions with retailer personnel, either on the floor or at a service desk. However, many retail locations do not have sufficient staff for such an approach and customers are frustrated by the difficulty in finding store personnel. Further, store personnel on the floor do not have access to information regarding inventory and backordering. A service desk may have such information, but the customer must seek out the desk and typically there are lines or other factors making this option undesirable to the customer.

Thus, there is a long-felt need to provide a system and method with which retail entities could quickly and easily interface with customers at a retail location to address the problem of out of stock items desired by the customers, before the customers leave the retail location. Specifically, the system and method should enable quick and easy communication without the need for the customer to seek retail personnel or be otherwise inconvenienced.

### SUMMARY OF THE INVENTION

The present invention broadly comprises a method for querying an end user, including the steps of generating, in a processor of a specially programmed general-purpose computer, a first query as to whether an item is out of stock at a first retail location or missing at the first retail location; and transmitting the first query from an interface element in the general-purpose computer to a communication network for transmission to a wireless communications device located in the first retail location. In some aspects, transmitting the first query further comprises transmitting a request to interface with the general-purpose computer and the method includes receiving in the interface element a transmission from the communication network including a response to the request to interface; authorizing, in the processor, continued communication with the wireless communications device through the interface element; and transmitting the authorization from the interface element to the communication network for transmission to the wireless communications device.

In some aspects, the method includes determining, using the interface element and the processor, that the wireless communications device is registered with the first retail location. In some aspects, the method includes receiving in the interface element a transmission from the communication network regarding an order for one of an out of stock item or a missing item, the order transmitted from the wireless communications device to the communication network. In some aspects, the method includes transmitting a second query from the interface element to the communication network for transmission to the wireless communications device, the second query including an option to authorize payment for the order. In some aspects, the method includes generating in the processor an offer regarding at least one option for gaining possession of the item; transmitting the offer from the interface element to the communication network for transmission to the wireless communications device; and receiving in the interface element a transmission from the communication network regarding selection of an option from the at least one option, the selection transmitted from the wireless communications device.

In some aspects, the method includes determining with the processor that the order is available at one of a different area of the first retail location and at least one second retail location, different than the first retail location; when the item is available at the at least one second retail location, transmitting a request from the processor through the interface element to the at least one second retail location to hold the item; generating in the processor a notification regarding the availability at the one of a different area of the retail location or at least one different second retail location; and transmitting the notification from the interface element to the communication network for transmission to the wireless communications device. In some aspects, the method includes generating a notification in the processor regarding availability of the order; and transmitting the notification from the interface element to the communication network for transmission to the wireless communications device.

In some aspects, the method includes determining with at least one of the interface element and the processor that the wireless communications device is disposed in the first retail location and wherein transmitting the first query further comprises transmitting in response to the determining that the wireless communications device is disposed in the retail location. In some aspects, the method includes generating in the processor a substitution offer regarding the order and transmitting the substitution offer from the interface element to the communication network for transmission to the wireless communications device. In some aspects, the method includes prior to transmitting the first query, receiving, in the interface element, a transmission from the wireless communications device via the communication network requesting connection with the interface element.

The present invention also broadly comprises an apparatus for querying an end user.

The present invention further broadly comprises a method for ordering an out of stock item, including the steps of: receiving, in an interface element for a specially programmed general-purpose computer, information displayed in a first retail location regarding an item for sale in the first retail location, the information transmitted from a wireless communications device via a communication network and uploaded to the wireless communications device using a data input function in the wireless communications device; and generating an order for the item in a processor of the general-purpose computer. In some aspects, the method includes generating, in the processor, a query regarding an option to authorize payment for the order and an offer regarding at least one option for gaining possession of the item; and transmitting the query and the offer from the interface element to the communication network for transmission to the wireless communications device.

In some aspects, the method includes determining with the processor that the order is available at one of a different area of the first retail location or a second retail location, different than the first retail location; generating in the processor a notification regarding the availability at the one of a different area of the first retail location or the second retail location; and transmitting the notification from the interface element to the communication network for transmission to the wireless communications device. In some aspects, the method includes generating in the processor, in response to receiving the information displayed in the first retail location regarding an item for sale in the first retail location, a substitution offer regarding a substitute item; and transmitting the substitution offer from the interface element to the communication network for transmission to the wireless communications device.

The present invention broadly comprises an apparatus for ordering an out of stock item.

It is a general object of the present invention to provide a system and method to enable communication between a retail entity and one or more customers at a retail location for the entity regarding the availability and/or location of items.

It is another object of the present invention to provide a system and method to enable customers at a retail location to order a desired item that is out of stock or not stocked or to order one or more substitute items for any one or more items that are out of stock or not stocked.

It is still another object of the present invention to provide a system and method to enable customers at a retail location to order out of stock items or non-stocked items using cell phones and other portable devices in the possession of or otherwise under the present control of the customer.

These and other objects and advantages of the present invention will be readily appreciable from the following description of preferred embodiments of the invention and from the accompanying drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a schematic block diagram of a present invention system for querying an end user; and,

FIG. 2 is a flow chart of a present invention method for querying an end user.

### DETAILED DESCRIPTION OF THE PREFERRED EMBODIMENT

At the outset, it should be appreciated that like drawing numbers on different drawing views identify identical, or functionally similar, structural elements of the invention. While the present invention is described with respect to what is presently considered to be the preferred aspects, it is to be understood that the invention as claimed is not limited to the disclosed aspects.

Furthermore, it is understood that this invention is not limited to the particular methodology, materials and modifications described and as such may, of course, vary. It is also understood that the terminology used herein is for the purpose of describing particular aspects only, and is not intended to limit the scope of the present invention, which is limited only by the appended claims.

Unless defined otherwise, all technical and scientific terms used herein shall include the same meaning as commonly understood to one of ordinary skill in the art to which this invention belongs. Although any methods, devices or materials similar or equivalent to those described herein can be used in the practice or testing of the invention, the preferred methods, devices, and materials are now described.

The following non-limiting definitions are applicable to the present invention:

Business—includes any business enterprise formed for the purpose of providing a product or service, which may or may not be for profit.

Business objective—includes any desired outcome of a business or business owner, including, for example, acquisition of new customers, delivery of one or more marketing offers, increases or improvements in product quality or service, sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Business Information—includes any information that is provided, known, gathered, assumed or is otherwise determined or stored that is related to or is about or otherwise helps understand, define, operate, improve, track or report the performance of, a business, for example, customer acquisition and sales data, marketing information, click-through rates, conversion rates, profit and loss information, accounting information, financial information, statistics and ratios, customer information, sponsor information, information about any one or more business, customer or sponsor objectives, or any other information, business metrics and data gathered or stored or otherwise possessed or accessible by a business and/or any of its affiliates, sponsors, customers or investors.

Controller—means any one or more of the following electronic devices including, but not limited to: cell phones, Personal Digital Assistants or (PDA's), Blackberry or similar devices, such as hand held computers, MP3 players, or any other personal electronic device that has one or more of a keyboard, speaker, microphone, one or more buttons, or any other similar devices that provides a User with Input and/or Output Functionality and Remote Connectivity. A Controller may be or include one or more of a Display and/or a Server or other computing devices or means of computing.

Coupon—includes an offer presented in the form of an electronic or printed ticket or document which may include a discount or rebate when purchasing one or more products from a business or sponsor. In certain embodiments, a coupon may include a bar code, RFID, or other means of identification, which may include information that can verify any one or more of the type of coupon, valid offer dates, customer, business or sponsor information, discount amounts, restrictions, permissions, items required to purchase to receive a discount or rebate, and/or items to which a discount or rebate applies, location information, including where the coupon is valid, e.g., which store or stores, or website, and/or any other information that might assist or be of benefit to the issuer or recipient or the processor, e.g., a cashier, and/or the processing system, e.g., a POS terminal or POS system, and/or a sponsor or other business entity, and/or any information that might encourage distribution, delivery, redemption or use of any such coupon or that might improve the results of any coupon or coupon marketing campaign, e.g., a viral marketing campaign or new product introduction.

Customer Facing Display—includes any device accessible by an end user or customer that includes at least one of a display, input means, e.g., a touch screen or keyboard, or other output means, e.g., a speaker. In certain embodiments, a Customer Facing Display may include a Kiosk, POS Terminal, or other computing device, such as a cell phone, PDA, laptop or PC. In certain embodiments a customer facing display may be a POS or POS terminal and vice versa.

Customer Identifier—includes, but is not limited to a cell phone, an RFID tag, a credit card, a debit card, a frequent shopper card or number, a coupon, a license plate, a check, a loyalty or gift card, fingerprint or other biometric input, a driver's license, or other identification means.

Customer Information—includes any information that is provided, known, gathered, assumed or is otherwise determined or stored that is related to or is about or otherwise helps understand or define a customer and/or a customer's buying habits, preferences or tendencies. Such information may include the customer's (or any related person, e.g., a child) order history, order contents, ideal order acceptance or rejection data, willingness to accept or reject one or more marketing offers or messages (either specific or types or categories of offers), price point or price elasticity, tendency to attempt to game other otherwise attempt to take advantage of the system or marketing program, average order total, e.g., average check, average item count, e.g., average number of items in a given order, average customer count, e.g., how many persons in the party on average, any demographic information, e.g., income, race, mailing address, zip codes, phone numbers, household total income, number of children, age, sex, number and type of internet enabled devices, participation in one or more marketing programs, willingness to use kiosks, cell phones or other ordering devices, prior ordering history, including willingness or tendency to accept pre, mid and/or post order marketing offers, e.g., suggestive selling, cross selling, sponsor rewards, or any other offers, and/or any other information gathered or provided by/from the customer, e.g., preferences information gathered by observing such customer behavior, e.g., does customer switch from cold beverages to hot beverages in the wintertime, and/or information gathered or supplied by a marketing program and/or by such customer when signing up or otherwise maintaining such information in a customer loyalty or other marketing program's database, or by importing or otherwise accessing information about such customer via any public or commercially accessible database and/or any combination of the foregoing information.

Customer Objective—includes any desired outcome, behavior that benefits a customer, including, for example, improved or better pricing, service, e.g., friendly service, speed of service, accuracy of service, quality of delivered products, types of marketing offers and/or savings associated with each, cleanliness of location, type of online or other ordering systems, including, e.g., POS devices, or any other favorable treatment or benefit that can be obtain or otherwise accrues to the benefit of such customer, and/or any combination of the foregoing.

Dilution—includes any outcome that has a net negative effect, e.g., an acceptance of an upsell or other offer results in providing a discount on an item, which a customer might otherwise have paid full price.

Discount—includes any price or offer at an amount other than the standard list price or expected price or shelf price, or displayed price, e.g., online.

Display—includes any one or more of the following electronic devices including, but not limited to: TV (of any technology type, including but not limited to a Plasma Display, LCD, CRT or DLP), Kiosk, LED display, Electronic Shelf Label, Automated Teller Machine (ATM), POS terminal, video game display, video slot machine or other video based casino games, speaker, or any other device capable of displaying, presenting or otherwise outputting or processing Output Materials (such as an LCD or other display in an airline seatback or other Location, e.g., a grocery cart equipped with a display and/or a bar code or RFID printer or reader), including devices that provide a User with Output Functionality. A Display may include or be one or more of a Controller and/or a Server and/or other computing device capable of providing Input and/or Output Functionality and/or Remote Connectivity.

Domain Name Server (DNS)—One or more computers including a cooperatively run set of databases, distributed among several servers, volunteered as repositories for IP address information.

End User—includes any person or entity making use of any one or more of the methods of the disclosed invention, and/or any system that uses or is based upon or benefits from one or more of the disclosed inventions, including, for example, customers, vendors, retailers, QSR operators, managers, employees, supervisors, friends, family members, or any other person as applicable to the given context or otherwise.

Existing Member—includes a member of a loyalty program or other marketing program and/or a person that has signed up for any marketing or other program and/or has provided information to such a program, whether or not such person is aware of such program, including, end users.

Frequent Shopper Program—includes any system that provides one or more rewards to members of such program for purchases made.

Frequency Program—includes any Frequent Shopper Program or other rewards system that rewards customers for their frequency of visit and/or buying one or more products, goods or services.

GUI—includes a graphical user interface, or other means of providing communications from or to an end user, including via graphics, text, audio, video, data input, such as voice, typing, touch screen, or other means of input or output to/from any device, including a POS Terminal, or other computing devices. Such GUI may include information and/or actions that are available for viewing, use or interaction with an end user. Such interaction may be accomplished via any applicable means, including, for example, manipulating icons, widgets or other items or areas displayed on such GUI, including, clicking on one or more hyperlinks, and/or entering information into fields or other areas designed for such purposes, e.g., typing a name, or selecting one or more items from a displayed list, etc. Header—A numeric code assigned to a request for content by either a LAN or ISP Server, which identifies a requestor's unique Internet Protocol Address. Generally, the Header is used for purposes of accurately returning a requested Mark-up Language-based electronic document as well as any corresponding files to the requestor.

Hyperlink—A text phrase or graphic embedded within a markup language-based electronic file, which corresponds to the address of a site on the World Wide Web.

Input Functionality—includes any one or more of any of the following, including but is not limited to any device that includes or provides one or more buttons (e.g., a keyboard) that can convey individual or grouped electrical signals, impulses, commands, or messages, or other tactile or other input device including a joy stick, mouse, touch screen, and/or audio (e.g., voice commands or instructions), bar code scanner, RFID reader, fingerprint or other biometric scanning device, scale, laser pointer, camera, infrared sensor, cell phone, hand held computer or PDA keypad, motion or other “presence” detector, magnetic card or magnetic card reader, and any other input method recognizable by or able to convey information to any one or more of a Display, Server, Controller or other computing device.

Internet—includes the world wide web and the network that is accessible by the public that includes a network of interconnected computers that transmit data using, for example, Internet Protocol (IP). In some aspects, certain private networks, including virtual private networks (VPN) may be included in the definition of the Internet.

Internet Device or Internet Enabled Device—includes any computing device that is capable of accessing or otherwise communicating with or via the Internet or any other network, client/server and/or peer-to-peer or any other network, and/or that is otherwise able to practice or benefit from any one or more of the herein disclosed inventions.

Internet Ordering or Online Purchase—includes the processing, in whole or in part, of any one or more transactions using or otherwise communicating via the Internet or other means of communications by or between any one or more of a business, sponsor and/or one or more customers, which transaction may be for or include the purchase, trade or acquisition of one or more items. In certain embodiments, internet ordering or online purchases may include the delivery of one or more marketing messages or marketing offers.

Item—includes any object, tangible or intangible, which may include any item for sale, rental, lease, consumption, transfer, and/or may be possessed or owned. Item may include any physical or virtual object. In certain embodiments an item may be any one or more of a food item, a beverage item, a dessert item, a retail good, a food product, a device, a POS device, a coupon, clothing, furnishings, groceries, automobiles, motorcycles, lighting, electrical equipment or devices, etc.

Kiosk—includes any device or location that permits a customer or end user to enter part or all of an order and/or respond to a marketing message or offer, with or without the assistance of a third party, e.g., a cashier. Kiosks may include software to prevent end users from performing unauthorized actions and/or accessing the system, operating system or other secure areas of the kiosk and/or systems to which it may be attached or connected, e.g., the Internet or one or more servers, etc.

Location—means and includes, but is not limited to retail stores, restaurants, bars, theme parks, casinos, video game parlors, Internet Café's, coffee bars, book stores, gas stations, convenience stores, hotel rooms, hotel or other lobbies, meeting rooms, office buildings, offices, airports, airplanes, government or other public services buildings, hospitals or any other public or private area or facility or residence that contains, possesses or otherwise provides limited or general access to at least one Display and/or practices part or all of any one or more embodiments of the present invention.

Loyalty or Frequent Shopper Member—includes any end user or person that has joined or signed up or opted into a loyalty program and/or frequent shopper program. Loyalty Member—a person that has signed up for or otherwise participates in a loyalty or frequent shopper program.

Loyalty Program—any system that permits users to sign up to receive rewards based upon such user's purchases or visitation frequency.

Marketing Message—Includes a marketing offer, or any other communication with an end user, e.g., a customer, which message may include any one or more of the following such as, any one or more of a graphic, logo, icon, price, discount or other offer, video, audio, or other visual, audio or static marketing or other content designed to communicate with or otherwise inform, educate or persuade a User. In certain embodiments, a marketing message may include one or more marketing offers.

Marketing Offer or Offer—includes any offer for sale of any item, good, product or service.

Marketing Program—includes any system that provides marketing messages, marketing content, loyalty programs, coupons, discounts, or any other offers or marketing offers, and/or tracks customer buying habits and other information, including customer information, such as locations, travels, demographics, ordering preferences, etc.

Markup Language—A set of codes in a text file that instructs a computer how to format the file for purposes of printing and/or display, as well as how to index and link the content of the file. Example markup languages include HTML, SGML, XML, VRML, and NRML.

Network Device—includes any device that can be interfaced with a technology network, for example, the Internet, a wireless communications network, (e.g., a cellular telephone system), a LAN, or a WAN.

Optimized—includes determining which marketing offer will likely or generally achieve the desired results or maximum results among or given one or more of several complimentary or competing objectives, including, for example, sales volume, gross margin, profits, customer accept rates, average check, speed of service times, product quality, freshness, customer satisfaction, customer frequency, order point, destination point or any other variables that affect or are of interest to one or more affected parties, e.g., the retail establishment, its suppliers and/or the customer. In certain embodiments, optimized includes finding the maxima or minima of a given function. In certain embodiments, the terms optimized and optimal have corollary meanings.

Output functionality—includes transmission of information via Remote Connectivity and/or conveying Output Materials on a Display and/or tactile feedback.

Output Materials means any one or more of the following, including but is not limited to any one or more of, Marketing Messages, audio, still images and/or video, flash and/or other animated sequences or materials, printed or visual reports or receipts, displayed information, information recorded to or stored on a hard drive or other computer readable medium, a text message, voice mail message, a sound such as a beep or bell or buzzer, audio messages (e.g. a voice prompt or marketing message or other information), including recorded, actual or synthetic voice messages, or any other output generated by a Display, Server, Controller, Network or other device or application that is sent to or processed by a User, Display, Server, Controller, Network or other device for subsequent viewing, listening and/or further processing or storage.

PC—includes a personal computer, such as a laptop, such as one provided by Dell Computers.

PDA—includes a personal digital assistant, such as Palm Pilot, or any other personal computing device, which includes at least one of a display, processor, memory or input or output means.

Point of Sale—includes any Point of Sale system or device that permits an end user to start, enter or complete an order or sales transaction, such as Panasonic's 7900 “all in one”, or any other POS devices, terminals or systems, websites, kiosks, PCs, PDAs, Cell Phones, call centers, slot machines, vending machines, and/or any other Internet or other device that provides access to any of the functionality or inventions disclosed herein and or any of the same or similar functionality and/or otherwise permits an end user to practice or benefit from any of the disclosed inventions. Point of Sale and POS shall have corollary meanings.

POS Device, includes a POS or other physical device that provides access to any of the features or inventions disclosed herein and or any of the same or similar functionality and/or otherwise permits an end user to practice or benefit from any of the disclosed inventions.

POS Terminal—includes a POS or other physical device that provides access to any of the foregoing and or any of the same or similar functionality and/or otherwise permits an end user to practice or benefit from any of the disclosed inventions.

Product—includes any machine, manufacture and/or composition of matter, unless expressly specified otherwise.

Prospective Member—includes any person that is not currently a member.

Referral—includes any prospective member identified or otherwise provided by an existing member.

Proximal, Proximity, Proximal/Proximity Data—includes any information about an end user's current or predicted whereabouts. Such information may include distance, i.e., distance between two points, e.g., a retail location and the end user, which distance may be measured directly, e.g., point A to point B, or based upon travel means, e.g., based upon the streets or other paths that a person or end user could actually use to travel from said point A to said point B, and/or may be based upon time, e.g., how long it might take a given end user to travel said distance between point A and point B, perhaps further as determined by such end user's current rate of travel or average rate of travel or method of travel, etc. Methods to calculate distances between to points in space and/or to estimate travel time are well known by those of ordinary skill in the art.

Referral Coupon—includes a marketing message, marketing offer, or other offer, including, for example, a coupon provided to an existing member for providing the identity or other information of a prospective member and/or an action taken by such prospective member, including, for example, such prospective member becoming a member and/or accepting a similar or other marketing offer, e.g., by redeeming a coupon.

Response—includes any action and/or failure to act by any person. For example, a response from a prospective member includes the immediate or subsequent reply to or use of one or more marketing messages or offers or other response, which response includes, but is not limited to, for example, signing up to one or more loyalty, frequency or other marketing programs, acceptance and/or use, e.g., redemption, of any one or more offers or coupon, opting in to one or more loyalty, frequency or other marketing program(s), achieving or maintaining a certain level of sales and/or number or frequency of store visits, purchases of certain products, providing one or more email addresses, visiting one or more retail, restaurant or other store location(s), ordering one or more items, or specific items, or failure to order one or more items or specific items, filling out a form or forms, or providing additional information, such as mailing address, phone number, internet device id information, and/or signing up for one or more third party sponsor programs, and/or any other action as determined or established by the marketing program, pressing one or more buttons and/or clicking on one or more hyperlinks or any combination of the foregoing. The terms response and respond shall have corollary meanings. In some embodiments a referral coupon may be a reward and/or a reward may be a referral coupon. In certain embodiments a referral coupon may be a viral coupon and vice versa.

Reports—in certain of the disclosed embodiments, one or more reports may be developed to provide tracking and/or analysis relating to any one or more data elements associated with any such embodiment or invention. Reports include any feedback or communication requested by or delivered to one or more end users, which may or may not require authorization to receive such report. Reports can be printed, verbalized using a text to speech conversion program, or displayed on any device, including, for example, a POS terminal or other computing device. Such reports may be created and/or delivered using any applicable means available. The methods to create and deliver reports are well understood and known within the industry and are disclosed in the prior art. Reports may be demand request, i.e., a report is generated only when or as requested, or exception based, i.e., a report is generated if a certain condition or conditions are met, not met or change in any defined way. In certain embodiments, reports are generated whenever desired or otherwise indicated or scheduled, and may be stored for subsequent use, which use may or may not be based on a request by an end user. Reports may include any one or more available database elements and/or calculated results based upon any one or more of the databases, database elements, mathematical or statistical manipulations, and/or any of the methods disclosed herein and/or as understood by any person skilled in the art and/or as requested/designed by one or more end users or other authorized personnel. For example, a report may include any one or more pieces of information contained or relating to customer, business or sponsor information, and/or POS transaction data and/or any or all results information generated or associated with any marketing offer or message.

Reward—includes any item or object or incentive that is or might be of benefit to its recipient, for example, a free or discounted item or a financial incentive, presented to an end user, e.g., an existing loyalty or marketing program member. In certain embodiments, rewards may be provided without any action of or by the recipient to receive such reward. In other embodiments, recipients must perform certain actions, e.g., purchase items from a business, or make a commitment to make such purchases, in order to receive, earn or otherwise qualify for any such reward(s). In some embodiments, a reward may be cash or an offer of cash or other financial currency or benefit. In certain embodiments, a reward may be an item, such as a toy, or a coupon. In yet other embodiments, a reward may be a combination of any or all of the foregoing. In certain embodiments, rewards may be created, funded or otherwise provided by businesses or sponsors. Rewards may be offered and/or delivered using any applicable means, including electronic transmission via the Internet, cell phones, text or voice mail, and may include one or more marketing messages or marketing offers. Rewards may be issued, granted or provided by individuals or groups and/or delivered or provided to individuals or groups. In certain embodiments, recipients of one or more rewards may be required to perform a certain task or tasks to qualify and/or to make use of one or more rewards. In some embodiments, rewards may be used only by the specific individual(s) who received the reward. In addition or in the alternate, rewards may be transferable or do not specify the recipient or require that only the recipient may benefit from such reward(s). In some embodiments a coupon may be a reward and/or a reward may be a coupon.

Viral Reward—includes any reward, coupon or other incentive designed to encourage additional use of such reward and/or to encourage one or more additional persons to join a loyalty or marketing program and/or to help achieve any other business, sponsor or customer objective(s). In some embodiments, viral rewards may be communicated via any applicable means, including, for example, via email, voice mail or text based messaging services. The terms viral reward, network reward, viral coupon, and network coupon shall have corollary meanings.

RFID—includes a radio frequency identification tag, transponder or similar devices.

Router—An intermediary device within a communications network that expedites message delivery. Within a single network linking many computers through several possible connections, a router receives transmitted messages and forwards them to their correct destination via an efficient available route.

Sensor—includes any application or device that can make a determination or otherwise detecting the change, presence or absence of something, including, for example, temperature, weight, sound, pressure, volume, mass, light, odors, and/or any recording, or registration, change, presence or absence of or to any data or other electronic media. In certain embodiments a sensor includes one or more transducers.

Sponsor—includes any third party or entity that provides product, goods or services and/or money or other financial means to an end user or retail entity in exchange for the option to communicate with such end user, including, for example, to provide one or more marketing messages or offers, including, e.g., a cross sell offer or sponsor reward.

Store—includes any one or more retail, restaurant or other location, and may include online locations, websites, kiosks, automated stores, e.g., vending machines, so called “brick and mortar” locations, and/or any combination of the foregoing, and/or access to any such location(s) using any POS device.

Sponsor information—includes any information that is provided, known, gathered, assumed or is otherwise determined or stored that is related to or is about or otherwise helps understand, define, operate, improve, track or report the performance of, a sponsor business, for example, customer acquisition and sales data, marketing information, click-through rates, conversion rates, profit and loss information, accounting information, financial information, statistics and ratios, customer information, sponsor information, information about any one or more sponsor objectives, or any other information, business metrics and data and/or business information gathered or stored or otherwise possessed or accessible by a sponsor and/or any of its affiliates, businesses, customers or investors.

Sponsor objective—includes any desired outcome of a sponsor or sponsor business owner, including, for example, acquisition of new customers, conversion of competitor's customers to sponsor's customers, delivery of one or more marketing messages or offers, increases or improvements in sales, profits, customer counts, customer visitation frequency, customer loyalty, average check, average item counts, order contents, speed of service measurements, labor rates, sales per labor hour, year over year or same store sales, percentage market share, annual or periodic growth rates, employee or management retention or turnover rate, inventory control or turns, inventory waste, raw or finished waste, increases in stock prices, improved return on assets or equity, or any other objective as determined by management or other authorized individual or as established by rules or other metrics including or stored in a system designed for such purposes.

Subscription—includes an agreement, which may be implicit or explicit, to purchase a certain quantity of goods, services, products or items and/or purchase the rights to use or access such goods, services, products or items, during or over a specified period of time, and/or an agreement to spend a certain amount of money over a certain period. In certain embodiments, subscriptions may be accepted through an action or failure to act by a subscriber or end user. In certain embodiments, subscriptions may automatically renew based upon an action or inaction of a subscriber or end user. In certain embodiments, a virtual subscription may be accomplished without formal agreement among the affected parties, e.g., by selling a razor that requires use of specific blades.

Tag—A code embedded within an markup language-based electronic file which associates one or more words or images within the document with a Uniform Resource Locator (URL) corresponding to another file. Within the art, a tag of this particular functionality may be referred to as an “HREF” (hypertext reference) tag.

Transaction—includes any communication or agreement between two or more entities, including end users, individuals, retailers, and/or computing systems. In certain embodiments a transaction can include a financial transaction wherein a seller sells and item and a buy buys an item, where such seller may experience an increase in finances while the buyer's finances may decrease. In certain embodiments, a transaction may include a communication between a computing system and an one or more end users, or between two computing systems, a computing system and a database or data repository, two end users, two or more data repositories, etc. In additional embodiments, a transaction includes a POS transaction, where a customer places and pays for one or more items, goods, services, or products and/or access to or use of any or all of the foregoing, and/or via a website and/or using a POS terminal or POS device.

Trial Coupon—includes any offer that encourages the purchase of a new item or an item an end user has not yet tried, which offer may be presented using any applicable means, including use of an electronic or printed coupon.

Upsell—includes any offer to purchase one or more items at a full, discounted or other price including the retail price. Upsells include offers to increase an order size, quantity, type or contents of an entity's, e.g., a customer's order.

Upsell/Instruction/Commission Output device—includes, but is not limited to: a POS terminal, a website, a drive through or other digital menu board, a drive through speaker, a cell phone, telephone, pager or PDA, a kiosk, a vending machine, a customer counter display, an in-store or other digital menu board, a display built into a restaurant table, a vending machine, a speaker, or slot machine.

User—includes any entity or person including a person making use or practicing the various disclosed embodiments of the invention. The terms user and end user shall include corollary meanings.

User-Visible Text Portion—A portion of markup language-based code which specifies the text or other images to be displayed to a Web user. An example (in bold) as well as the corresponding tag (underlined) follows: Ex. <A HREF=“http://go.msn.com/npl/msnt.asp” target=“_top”><IMG SRC=“/chan/home/logo.gif” WIDTH=140 HEIGHT=60 BORDER=0 ALT=“Go to msn.com”>Microsoft Network</A>

Web Browser—A client application that enables a user to view markup language-based documents on the World Wide Web, another network, or the user's computer; utilize the hyperlinks among the documents, as well as transfer and execute files within the documents.

Web Site—A subset of the World Wide Web comprising a collection of files, documents and graphics made generally available to others through the Internet. In certain embodiments a web site may include means for conducting a transaction, including, for example, a POS transaction.

Wireless Communications Device (WCD)—A communications device that transceives via a non-wired medium, such as radio frequency. A WCD can include, but is not limited to an AM or FM radio device, a television, cell phones, portable phones, and devices, such as laptop computers and PDAs interfaced with a wireless network, for example, a LAN. Applicable formats, standards or protocols, include Ethernet (or IEEE 802.3), SAP, ATP, Bluetooth, and TCP/IP, TDMA, CDMA, and 3G.

World Wide Web—The total set of inter-linked hypertext documents residing on Hypertext

Computing. It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions. A “processor” means one or more microprocessors, central processing units (CPUs), computing devices, microcontrollers, digital signal processors, or like devices or any combination thereof.

A description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software or hardware only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on the Intel® Pentium® or Centrino™ processor, that are adapted to communicate with the computer. Any number and type of devices may be in communication with the computer.

Remote Connectivity means any method used by a Controller, a Display or a Server or other computing devices to communicate with other devices or networks including, but not limited to the Internet, Satellite networks, Cell Phone networks, other wireless networks and standards such as 802.11, 80211.b, 802.11g, or similar wireless LAN operating standards, or Bluetooth technologies, infrared connections, or any other similar technologies or other technologies such as those described above that permit the sending and/or receiving and/or processing of electronic information in either an encrypted or unencrypted format.

Server means one or more computing systems that include at least one of a processor, computer readable medium, or input/output capabilities and may have local or Remote Connectivity capabilities. Servers may be local or remote to Displays or both. A Server may be or include one or more of a Display and/or a Controller.

In an embodiment, a Server computer or centralized authority may not be necessary or desirable. For example, the present invention may, in an embodiment, be practiced on one or more devices without a central authority. In such an embodiment, any functions described herein as performed by the Server computer or data described as stored on the Server computer may instead be performed by or stored on one or more such devices.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

“Determining” something can be performed in a variety of manners and therefore the term “determining” (and like terms) includes calculating, computing, deriving, looking up (e.g., in a table, database or data structure), ascertaining, recognizing, and the like. A “display” as that term is used herein is an area that conveys information to a viewer. The information may be dynamic, in which case, an LCD, LED, CRT, LDP, rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as standard definition (SDTV), enhanced definition (EDTV), high definition (HD), or the like. The information may likewise be static, in which case, painted glass may be used to form the display. Note that static information may be presented on a display capable of displaying dynamic information if desired.

The present disclosure may refer to a “control system”. A control system, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, CPU devices, computing devices, microcontrollers, digital signal processors, or like devices. Exemplary processors are the INTEL PENTIUM or AMD ATHLON processors. The term “computer-readable medium” refers to any medium that participates in providing data (e.g., instructions) that may be read by a computer, a processor or a like device. Such a medium may take many forms, including but not limited to, non-volatile media, volatile media, and transmission media. Non-volatile media include, for example, optical or magnetic disks and other persistent memory. Volatile media include DRAM, which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during RF and IR data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, TDMA, CDMA, GSM, EDGE, GPRS, WCDMA, AMPS, D-AMPS, IEEE 802.11 (WI-FI), IEEE 802.3, SAP, SAS™ by IGT, OASIS™ by Aristocrat Technologies, SDS by Bally Gaming and Systems, ATP, TCP/IP, gaming device standard (GDS) published by the Gaming Standards Association of Fremont Calif., the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

The present disclosure provides, to one of ordinary skill in the art, an enabling description of several embodiments and/or inventions. Some of these embodiments and/or inventions may not be claimed in the present disclosure, but may nevertheless be claimed in one or more continuing applications that claim the benefit of priority of the present disclosure.

It will, of course, be understood that the foregoing description is of exemplary embodiments of the invention and that the invention is not limited to the specific embodiments shown. Various changes and modifications will become apparent to those skilled in the art and all such variations and modifications are intended to come within the spirit and scope of the appended claims.

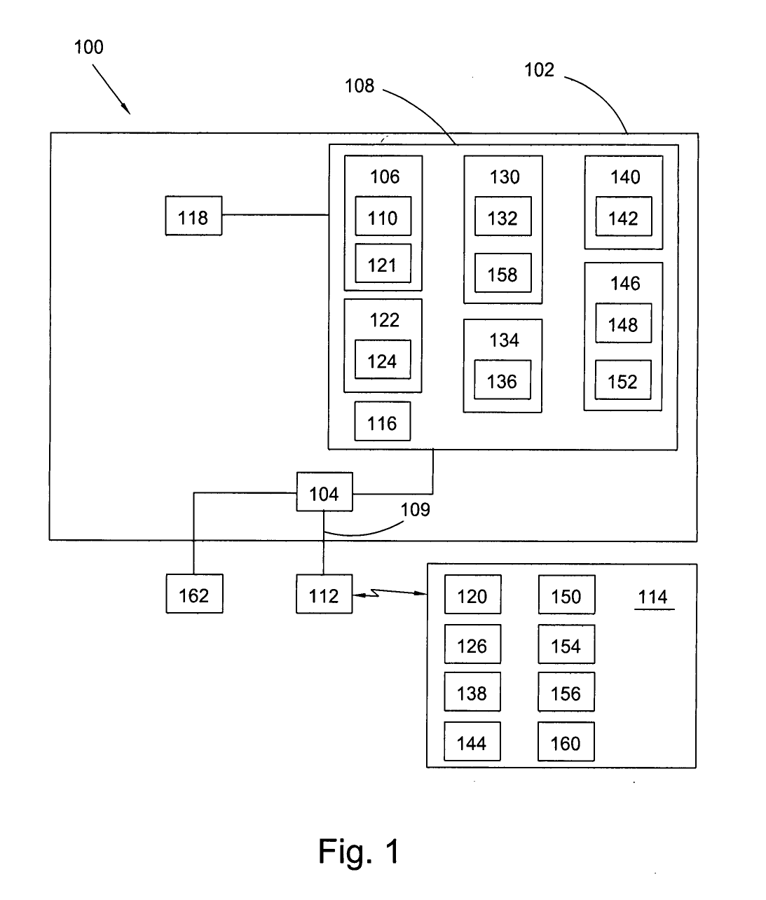

FIG. 1 is a schematic diagram of present invention system 100 for querying an end user. System 100 includes specially programmed general-purpose computer 102, interface element 104, and query element, or function, 106 in processor 108. Alternately stated, elements 104 and 106 and any other elements described as being in the processor are functions of the processor or are functions carried out by the processor. Computer 102 is associated with a retail location (not shown). By retail location, we mean a location where goods are offered for sale and are kept on hand for dispersal or subsequent shipment or delivery to customers. Goods can be offered by any pricing structure known in the art, for example, goods can be offered at manufacturer's list prices available to the general public or can be offered at wholesale prices only available to prospective customers meeting certain requirements. It should be understood that system 100 is not limited to use with a single, physical location. For example, the retail location can be associated with a plurality of other retail locations, e.g., the retail location is part of a chain of stores, and system 100 can be in place at any or all of the locations. By interface element, we mean any combination of hardware, firmware, or software in a computer used to enable communication or data transfer between the computer and a device, system, or network external to the computer. Computer 102 can be any computer or combination of computers known in the art. Processor 108 and interface element 104 can be any processor or interface element, respectively, or combination thereof, known in the art. The interface element can connect with the device, system, or network external to the computer using any means known in the art, including, but not limited to a hardwire connection, an optical connection, an Internet connection, or a radio frequency connection. In the figures, a non-limiting example of a hardwire connection 109 is shown.

The query element is arranged to generate query 110. Query 110 is directed to whether an item (not shown) is out of stock at the retail location or missing at the retail location. The query is directed to an end user as described infra. The interface element is arranged to transmit the query to a communication network 112, using any means known in the art, for transmission to wireless communications device 114. The interface element also is arranged to receive a transmission from the communication network regarding, or, placing an order for, an out of stock item or a missing item in response to query 110. The order is originated by the end user and is sent from the wireless communications device to the communication network.

In some aspects, processor 108 includes locating element, or function, 116 arranged to determine when the wireless communications device is disposed in the retail location. Element 116 can be any combination of hardware, firmware, and software known in the art or is otherwise described herein. System 100 and element 116 can use any means known in the art to identify wireless communications device 114, in particular, when the device is disposed in the retail location. In some aspects, element 116 uses element 104 and network 112 to determine the location of device 114. For example, when device 114 includes a GPS element, element 116 can access a respective GPS identification number or GPS information regarding the location of the device via a network associated with the device, for example, network 112. If device 114 is a cell phone, the number for the phone can be stored in memory element 118 in the computer and accessed by element 116. Also, an IP address for device 114 can be used. In some embodiments, appropriate detection elements (not shown) are located at or generally near or within useful operable distance from points of egress for the retail location to detect the passage of the device into the retail location and these detection elements are interfaced with element 104. In some embodiments, the device may be configured or provided with hardware or software to generally assist in identifying the entry of the device into the retail location. Memory element 118 can be any memory element known in the art. In one embodiment, device 114 is connectable to a docking station (not shown), for example, a docking station on a shopping cart, to enable element 116 to identify device 114. Any docking station or docking means known in the art can be used. That is, when the device is connected to the docking station, a link is established between the device and system 100. The docking station is interfaced with element 104 via a wireless connection.

In general, a person in possession of device 114, which device may or may not be owned by such person, e.g., such device may be owned by the business and loaned or otherwise provided to such person, or such device may be owned by such person, e.g., a cell phone or PDA or other Internet or wireless enabled device, is referred to as an end user and an end user is assumed to be an owner of device 114 or a person authorized by the owner of device 114 to use the device or is otherwise in current possession of such device. Alternately stated, the end user is associated with device 114, by which we mean that the device is owned by the end user, registered to or otherwise controlled by the end user, or otherwise linked to the end user such that an identification of the device enables authorized identification of the end user. In some embodiments, the end user is a known customer of the business entity (not shown) associated with the retail location. For example, the end user is registered with the business entity or the retail location. The registration can be in the form of a loyalty program or similar arrangement. In some embodiments, memory element 118 includes data regarding the customer and device 114, for example, customer information as defined supra. In some embodiments (not shown), the computer has access to a remote memory element containing data regarding the customer, for example, through system 112, which information may include customer information or objectives.

Thus, after determining that device 114 is generally located in the retail location, query element 106 generates query 110 asking the end user if the end user has been unable to procure one or more desired items, for example, has been unable to find one or more items because the item(s) is/are out of stock or does not appear to be stocked in the retail location. It should be understood that any number of desired items can be identified in response to query 110, that is, there can be more than one desired item and/or substitutable item(s). The query includes a prompt for the end user to place an order, using device 114, for the desired item(s). Thus, if an item at the retail location is out of stock or is not stocked at the retail location, system 100 provides the end user with the option, via query 110 and device 114, to immediately order the desired item or another item that may be a substituted item, as further described infra, which may or may not be generally similar to the desired item.

In some aspects, an end user can initiate the process of communicating with the interface element. For example, the end user can use device 114 to call a telephone number associated with the retail location or the business entity. For example, interface element 104 receives the signal and communicates with the processor to initiate and authorize the query element to begin the above described operation. In response to receiving the call, the query element then transmits query 110.

Using device 114, the end user is able to reply to the query by identifying an out-of-stock or missing item that the end user wishes to purchase and agreeing to purchase the desired item. Thus, if the end user chooses to respond to the query, for example, by ordering the desired item, the end user can generate order 120 in device 114, and can use the device to transmit the order to element 104. Any means known in the art can be used to display the query and generate order 120 in device 114. In some embodiments, each desired item is correlated to a key on a keypad for device 114 and the end user touches the respective key to order a desired item. In some embodiments, each desired item is displayed as an icon on a GUI for device 114 and the end user touches the respective icon to order a desired item. In some embodiments, the end user enters an identification associated with the desired item. Such entry may be accomplished via any applicable or available means, for example, a data input function in device 114. For example, if device 114 is a cell phone equipped with a camera, the entry is accomplished by scanning a bar or other identification code on a shelf label or other display or interface device (not shown) using the camera. Also, if device 114 is equipped with a bar code scanner, shelf tag reader, or RFID reader/scanner, information on a shelf label and/or other display or interface device (as applicable) can be inputted using the bar code scanner, reader, or RFID reader. In certain embodiments, if such device lacks any or all such scanning, reading or other devices, the end user may choose to enter product identification information to substitute for such scanning or reading method step.

In some embodiments, the query element generates query 121 for transmittal by the interface element to device 114. The query includes a prompt for the end user to provide, or otherwise permit the system to retrieve, information and authorization regarding a method of payment for the desired item in order 120. The method of payment can be any payment method known in the art and compatible with wireless communications. For example, the payment can be using a credit card or can be an account associated with the wireless device. For example, when system 112 is a cellular telephone system, the payment can be applied to the cellular telephone system account for device 114 or other payment method associated with such cellular telephone system and/or, as provided by an existing or provided customer account, which may be stored along with other customer or system information. In some embodiments, when an end user has agreed to provide payment methods, for example, by opting into a loyalty or other marketing program and/or by agreement with a cell phone or other network provider, the end user can authorize payment for the item with a single click and/or by pressing one or more subsequent buttons or speaking one or more commands, and/or via any applicable means available. In some aspects, payment alternatives include digital wallets such as those provided by Paypal, Google, and Amazon.

In some embodiments, system 100 includes offer element, or function, 122 in processor 108, arranged to generate offer 124 regarding at least one option for gaining possession of the desired item in order 120. Element 104 transmits the offer to network 112 for transmission to device 114. For example, when element 104 receives order 120, element 122 determines the options available to the end user for obtaining the desired item, for example, picking up the item or delivery of the items and includes these options in offer 124.

Using device 114, the end user is able to reply to offer 124 by selecting one of the options included in offer 124, generating order 126 including the selected option, and transmitting the order to network 112. Any means known in the art can be used to generate order 126 in device 114. In some embodiments, each option is correlated to a key on a keypad for device 114 and the end user touches the respective key to select an option. In some embodiments, each option is displayed as an icon on a GUI for device 114 and the end user touches the respective icon to select an option. Element 104 is arranged to receive order 126 from network 112. Thus, for example, the end user can opt, via order 126, to pick up the item on a subsequent visit to the retail location or have the item delivered to a specified location. In certain embodiments, the end user may accept offer 124 or order 126 by speaking a command.

Using order 126, the end user can choose pick up and/or delivery instructions, e.g., to pick up the item at a designated location, time and/or date, and/or to have the item delivered. Such delivery may be to a known address, for example, an address in the customer information, and/or the end user may be required or may choose to provide an alternative address for such delivery, which address may be stored for future use, e.g., in customer information. Any fee arrangement known in the art can be used with a delivery selected in order 126. For example, the delivery can require payment of a delivery fee, and/or such fee can be reduced or eliminated.

In some embodiments, system 100 includes notification element, or function, 130 in processor 108, arranged to generate notification 132 regarding availability of order 126. For example, notification 132 includes information as to when the desired item is available for pick-up or delivery. In some embodiments, element 104 is arranged to transmit the notification to system 112 for transmission to device 114. In some embodiments, system 100 repeats transmission of notification 132 after device 114 has been detected as leaving the location. For example, when actual availability of the desired item is confirmed (the device is available for pick-up or delivery), element 130 modifies the notification to include the updated information and element 104 transmits the updated notification. The updated notification can be resent to the end user using any means known in the art, for example, via device 114, via another wireless communication device (not shown) associated with the end user, or to an email account (not shown) associated with the end user. The updated information can be sent to network 114 and/or another network(s) (not shown), such as the Internet. In some embodiments (not shown), an end user can visit a website to determine the status of the desired item.

In some embodiments, element, or function, 134 in the processor identifies one or more substitute items for the desired items, for example, information for which is stored in element 118, and generates offer 136 including the substitute items. For example, element 134 identifies one or more items that may be similar in configuration or function and/or price or other means of comparison to the desired item and that are in stock at the retail location. Element 104 is arranged to transmit offer 136 to communications network 112 for transmission to device 114.

Using device 114, the end user is able to reply to offer 136 by declining or accepting, or selecting one or all of substitute items included in offer 136, generating order 138 including some or all of the selected substitute item(s), and transmitting the order to network 112. Any means known in the art can be used to generate order 138 in device 114. In some embodiments, each substitute item is correlated to a key on a keypad for device 114 and the end user touches the respective key to order a substitute item. In some embodiments, each substitute item is displayed as an icon on a GUI for device 114 and the end user touches the respective icon to order a substitute item. Element 104 is arranged to receive order 138 from network 112. Thus, system 100 provides the end user the possibility of immediately obtaining a substitute item that may be suitable for the end user's needs. Further, system 100 offers the end user one or more other items that are similar or might otherwise be acceptable as an alternative to the desired item. In certain embodiments such a substitute item may be offered with or without a discount or other incentive. Such incentive or discount may be provided to reward or otherwise compensate an end user for the inconvenience of having to review, order or accept such a substitute item, and/or to provide a price that the system determines will provide sufficient incentive to encourage said end user to accept such a substitute item and/or in the even that the price of the substitute item is different than that of the desired item, to adjust the substitute item's price to be generally similar or the same, or otherwise sufficiently similar to said desired item's price so as to encourage said end user to accept the alternative or substitute items It should be understood that more than one substitute item is included in the spirit and scope of the claimed invention.

In some embodiments, system 100 includes availability element, or function, 140 in the processor arranged to determine whether the desired item or substitute item is available in another part of the retail location, at one or more other another retail locations (not shown), or via an online or website ordering method. For those cases in which the desired or substitute item is available at the other location, element 140 prompts the interface element to contact the other location with a request to hold the desired or substitute item. That is, arrangement is made to ensure that the desired or substitute item is actually available and will remain available. Element 140 then generates offer 142 including the option to obtain the desired or substitute item at the other location. Element 104 is arranged to transmit offer 142 regarding the availability of the desired or substitute item at the other location or locations to network 112 for transmission to device 114. Offer 142 can include an option to authorize payment for the desired or substitute item using device 114 while at the location and directions to the other location(s). In certain embodiments, one or more such alternative locations may provide a discount or other incentive to purchase and/or otherwise pick up such desired or substitute items, which incentives or discounts may or may not be the same for any or all such alternative locations. For example, a given alternative location with excess inventory of the desired or alternative item may provide a greater discount or incentive than another alternative location that has few or generally fewer remaining items or alternative items.

Using device 114, the end user is able to reply to offer 142 by accepting the option to obtain the desired or substitute item at the other location one, generating order 144 including the acceptance, and transmitting the order to network 112. Any means known in the art can be used to generate order 144 in device 114. In some embodiments, each option (decline or accept) is correlated to a key on a keypad for device 114 and the end user touches the respective key to select an option. In some embodiments, each option is displayed as an icon on a GUI for device 114 and the end user touches the respective icon to select and option. Element 104 is arranged to receive order 144 from network 112. In certain embodiments, the end user generate order 144 by speaking a command.

In some embodiments, in response to order 144, offer element 122 is arranged to generate offer 124 regarding at least one option for gaining possession of the desired item in order 144 from the other retail location. Element 104 transmits the offer to network 112 for transmission to device 114. For example, when element 104 receives order 144, element 122 determines the options available to the end user for obtaining the desired item, for example, picking up the item or delivery of the items and includes these options in offer 124. In some embodiments, system 100 notifies the second location to hold the desired item and otherwise facilitates the process of obtaining the desired item from the other location.

Using device 114, the end user is able to reply to offer 142 by selecting one of the options included in offer 142, generating order 144 including the selected option, and transmitting the order to network 112. Element 104 is arranged to receive order 144 from network 112. Thus, the end user can opt, via order 144, to pick up the item at another location or have the item delivered to a specified location from the other location. In some aspects, the other location is another retail location, a warehouse or other wholesale distribution location, a fulfillment center, or any other location known in the art from which an end user could obtain the item.

In some embodiments, element 104 sends an alert or other message to appropriate employees at the retail location in response to receipt of order 120. Typically, the appropriate employees are responsible for product ordering, stocking and/or customer assistance or the appropriate employee is designated to notify those employees responsible for product ordering, stocking, and/or customer assistance and/or other designated employee(s). The alert can contain some or all of the following: a notice as to where the end user is located in the store; identification of the desired item; and identification of substitute items. The substitute items can be items of specified quality or grade with respect to the desired item, or that have some of, all of, or more than the features or benefits of the desired item. The information in the alert can be used by an employee to further assist the end user with finding a satisfactory conclusion to having identified a desired item. The alert also can include authorization for the employee to offer a discount offer to the end user, and can include further instructions or authorization as to whether the employee has some or complete discretion as to when to offer the discount or as to the content of the discount offer.

In some embodiments, in response to orders 120 or 138, marketing element, or function, 146 determines offer 148, which can include, but is not limited to, a discount, a marketing offer or message, which may include a comparison between the desired and substituted item or items, or an Upsell as compensation for inconvenience suffered by the end user and/or as enticement to continue to do business at the retail location or with a business entity associated with the retail location. For example, offer 148 could include a two for one offer or a discount off a substitute item and/or include a discount on another related or unrelated item. As another example, if a first brand of an item is out of stock, a vendor providing a similar item under a competitive brand could provide, in offer 148, the end user with a discount to try the competitive item. Meanwhile, in addition or in the alternate, the vendor for the first brand could offer, in offer 148, a substitute product, which may or may not be offered at a discount. Such a discount, if any, may or may not depend upon the existence of one or more offers provided by the vendor of the first brand or competitor(s) of the vendor and may or may not be based upon or otherwise calculated/determined or affected by discounts or offers presented by such other competitor(s). For example, if the vendor of the first brand offered a 20% discount to try the first brand product in offer 148, a competing vendor could provide the end user with a 50% discount in offer 148 to try a product provided by the competing vendor. It should be understood that offer 148 is not limited to any particular percentages or differences in percentages and/or number of potential competing offers or vendors or items. A vendor could provide an item(s) free of charge, for example, if the end user is known to the provider, for example, through customer information, and is a valued customer or otherwise frequently buys the item(s) when the item(s) is in stock. Element 146 is arranged to send offer 148 to element 104 for transmission to device 114.

In some aspects, offer 148 is dynamic or flexible. For example, system 100 enables an end user to present a counter offer for a substitute item. The system could then reject the counter offer or respond with another offer. As another example, system 100 could present a follow up offer if the end user rejects offer 148. For example, the follow up offer could include a larger discount or other increased incentive for the end user to accept the follow up offer.

Using device 114, the end user is able to reply to offer 148 by declining or selecting one or all of the elements included in offer 148, generating order 150 including the selected elements, and transmitting the order to network 112. Any means known in the art can be used to generate order 150 in device 114. In some embodiments, each element of offer 148 is correlated to a key on a keypad for device 114 and the end user touches the respective key to select an element. In some embodiments, each element in offer 148 is displayed as an icon on a GUI for device 114 and the end user touches the respective icon to select an element. Element 104 is arranged to receive order 150 from network 112. It should be understood that offer 148 can be a single offer transmitted to device 114 or can be a series of related offers transmitted to device 114 at varying times.

The various elements of offer 148 can be made available to the end user using any means known in the art. For example, electronic coupons can be sent to an email account associated with the end user or a discount can be displayed on a GUI for device 114 for use at a POS in the retail location.

In some embodiments, element 146 generates incentive 152 for presentation to the end user. Incentive 152 is in addition to the elements noted above in offer 148, that is, incentive 152 is not linked to the particulars regarding the desired item. Alternately stated, incentive 152 addresses the general inconvenience that may be experienced by the end user regardless of the desired item. The incentive can include, but is not limited to: one or more coupons good for money or a percent off a current or a future purchase; another discounted item, e.g., a substituted item, coupon, gift certificate; or points that may be useful within a loyalty or other marketing program. Element 146 is arranged to send incentive 152 to element 104 for transmission to device 114.

Using device 114, the end user is able to reply to incentive 152 by declining or selecting one or all of the elements included in incentive 152, generating order 154 including the selected elements, and transmitting the order to network 112. Any means known in the art can be used to generate order 154 in device 114. In some embodiments, each element of incentive 152 is correlated to a key on a keypad for device 114 and the end user touches the respective key to select an element. In some embodiments, each element in incentive 152 is displayed as an icon on a GUI for device 114 and the end user touches the respective icon to select an element. Element 104 is arranged to receive order 154 from network 112.

In some embodiments, an end user can check on the status of the desired item included in order 120 or the status of the option selected in order 126. For example, the user generates inquiry 156 regarding the respective status and transmits the inquiry to network 112. The inquiry can be generated by device 114, another wireless communications device, an Internet enabled device, such as a laptop computer, or any other means known in the art. In response to the inquiry, element 130 generates status report 158 regarding the item in order 120 or the status of order 126. The report is sent to element 104 for transmission to the device generating inquiry 156 or any other suitable device. In certain embodiments, the end user may receive information as to the future availability of a desired or substitute item at the current or other retail location(s).

In some embodiments, element 104 is arranged to accept order 160 to change, add items to, or delete items from orders 120 or 138; to cancel orders 120 or 138; or to conduct any other transactions of interest and/or that are made available via system 100. For example, the end user could increase the number of items in an order, change the brand of an item, or redeem a coupon. In response to order 160, the system modifies the desired item or the substitute items, respectively, accordingly. Element 122 also receives order 160 and modifies offer 124 as necessary. Offer 124 is then transmitted to the end user as described and element 104 is arranged to receive a modified order 126 as necessary and as described supra. To transmit order 160, a customer can access element 104 using device 114, another wireless communications device, an Internet enabled device, such as a laptop computer, or any other means known in the art. Any security or identification verification scheme known in the art can be used in conjunction with order 160.

In some embodiments, end users in the location are identified through an action taken by the end users themselves, such as by swiping a card (not shown) in card reader 162 connected to interface element 104. In these embodiments, the end users provide information necessary for network 112 to interface with a wireless communications device, for example, device 114, as needed to provide the functionality described supra. For example, if device 114 is a cell phone, the user can provide a number or IP address for the phone and system 100 correlates the card and phone number and/or IP address, for example, in element 116. Then, when reader 162 detects the card, system 100 initiates contact with the cell phone, for example, by generating and sending query 110. Other methods for identifying an end user and establishing contact with the end user include the end user providing a GPS identification number or IP address, and/or a license plate number, which are then identified by system 100. For example, license plates can be scanned at an entrance to a parking lot for the retail location.

In some embodiments, devices 114 are supplied by the retail location to end users for use in the retail location.

In some embodiments, system 100 uses the identification means described supra to retrieve information about an end user, e.g., customer, business or sponsor information and/or objectives, which information or objectives may be further used to better or optimally determine if an offer or marketing message should be sent or otherwise provided to the end user.

Computer 102 can be any computer known in the art. In some embodiments, the computer is located in the retail location. In some embodiments, all or parts of the computer are remote from the retail location. In some embodiments (not shown) computer 102 is associated with more than one retail location, that is, the computer provides the functionality described supra at more than one retail location. Device 114 can be any wireless communications device, described supra, known in the art. System 112 can be any wireless communications network known in the art, see definition supra. Computer 102 and system 112 can be interfaced in any way known in the art. In some embodiments, system 112 is remote from system 100. In some embodiments a remote system 112 is a commercial cellular telephone network or a WAN. In some embodiments (not shown), system 112 includes a local interface in the retail location, for example, a wireless router. In some embodiments (not shown), system 112 is a LAN located in the retail location and substantially restricted to functioning in the retail location. For example, system 112 is a Bluetooth and/or infrared enabled system.

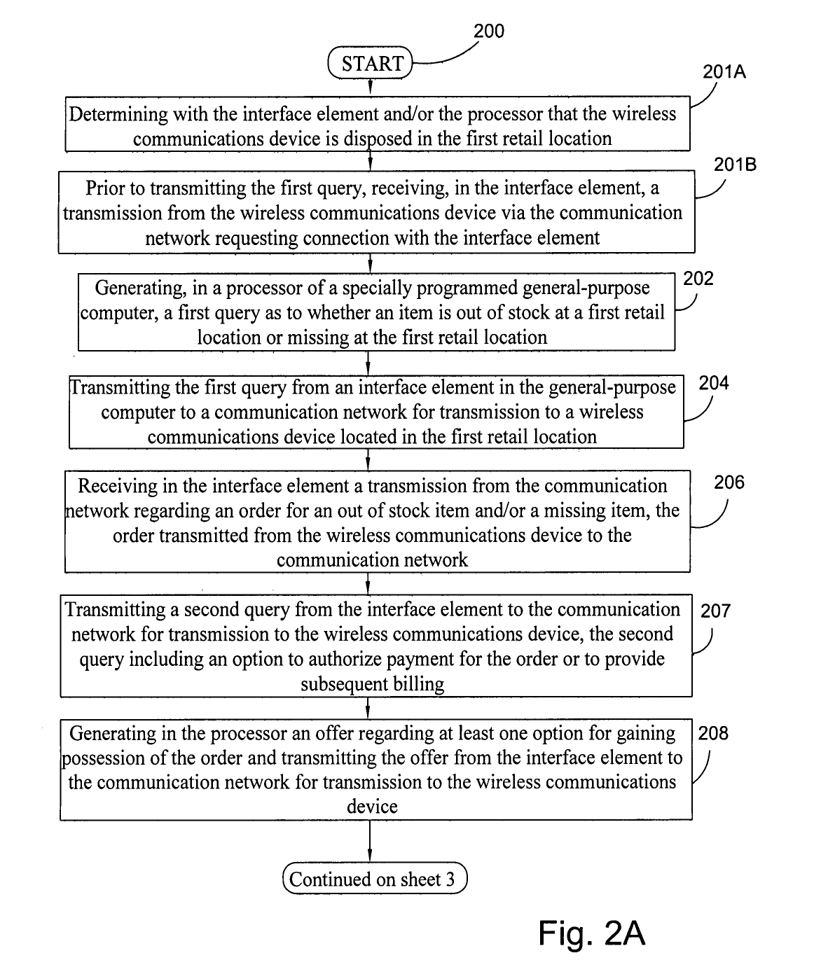

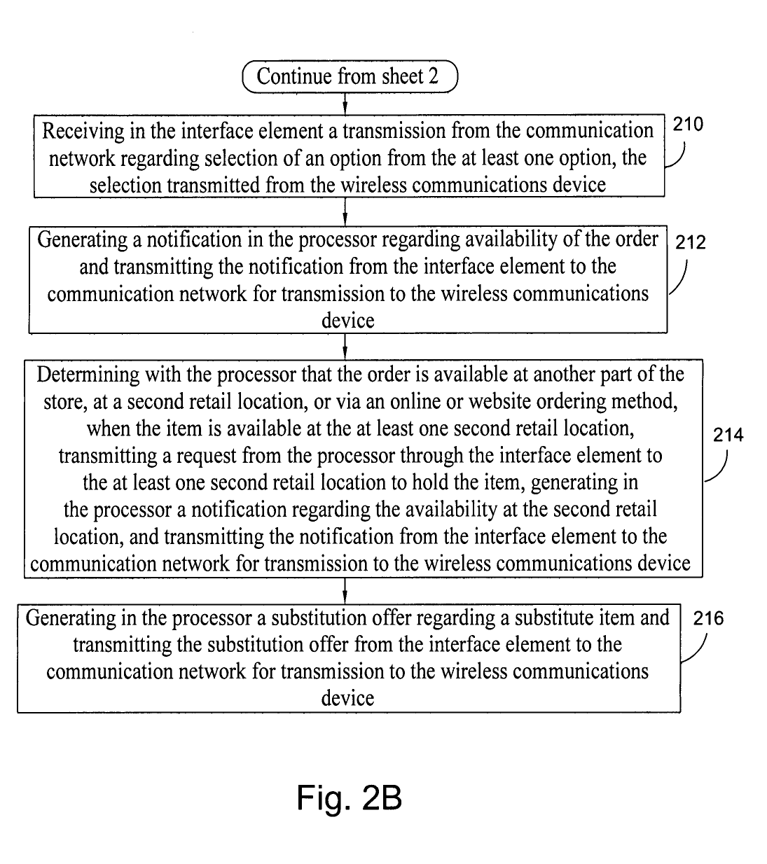

FIG. 2 is a flow chart illustrating a present invention method for querying an end user. Although the method in FIG. 2 is depicted as a sequence of numbered steps for clarity, no order should be inferred from the numbering unless explicitly stated. The method starts at Step 200. Step 202 generates, in a processor of a specially programmed general-purpose computer, a first query as to whether an item is out of stock at a first retail location or missing at the first retail location. Step 204 transmits the first query from an interface element in the general-purpose computer to a communication network for transmission to a wireless communications device located in the first retail location. In some aspects, step 206 receives in the interface element a transmission from the communication network regarding an order for an out of stock item and/or a missing item, the order transmitted from the wireless communications device to the communication network.

In some aspects, step 207 transmits a second query from the interface element to the communication network for transmission to the wireless communications device, the second query including an option to authorize payment for said order or to provide subsequent billing. In some aspects, step 208 generates in the processor an offer regarding at least one option for gaining possession of the order and the interface element transmits the offer to the communication network for transmission to the wireless communications device. In some aspects, step 210 receives in the interface element a transmission from the communication network regarding selection of an option from the at least one option, the selection transmitted from the wireless communications device. In some aspects, step 212 generates a notification in the processor regarding availability of the order and transmits the notification from the interface element to the communication network for transmission to the wireless communications device. In some aspects, step 214 determines with the processor that the order is available at another part of the store, at a second retail location, or via an online or website ordering method, when the item is available at the at least one second retail location, transmits a request from the processor through the interface element to the at least one second retail location to hold the item, generates in the processor a notification regarding the availability at the second retail location, and transmits the notification from the interface element to the communication network for transmission to the wireless communications device.

In some aspects, step 216 generates in the processor a substitution offer regarding a substitute item and transmits the substitution offer from the interface element to the communication network for transmission to the wireless communications device. In some aspects, step 201A determines with the interface element and/or the processor that the wireless communications device is disposed in the first retail location, then, step 202 transmits the query in response to the determination that the wireless communications device is disposed in the first retail location. In some aspects, step 201B, prior to transmitting the first query, receives, in the interface element, a transmission from the wireless communications device via the communication network requesting connection with the interface element. In some aspects, step 201A includes determining, using the interface element and the processor, that the wireless communications device is registered with the first retail location.

The present invention also includes a method for ordering an out of stock item. Although the method is described as a sequence of steps for clarity, no order should be inferred from the sequence unless explicitly stated. A first step receives, in an interface element for a specially programmed general-purpose computer, information displayed in a first retail location regarding an item for sale in the first retail location, the information transmitted from a wireless communications device via a communication network and uploaded to the wireless communications device using a data input function in the wireless communications device; and a second step generates an order for the item in a processor of the general-purpose computer. In some aspects, a third step generates, in the processor, a query regarding an option to authorize payment for the order and an offer regarding at least one option for gaining possession of the item; and a fourth step transmits the query and the offer from the interface element to the communication network for transmission to the wireless communications device.

In some aspects, a fifth step determines with the processor that the order is available at one of a different area of the first retail location or a second retail location, different than the first retail location; a sixth step generates in the processor a notification regarding the availability at the one of a different area of the first retail location or the second retail location; and a seventh step transmits the notification from the interface element to the communication network for transmission to the wireless communications device. In some aspects, an eighth step generates in the processor, in response to receiving the information displayed in the first retail location regarding an item for sale in the first retail location, a substitution offer regarding a substitute item; and a ninth step transmits the substitution offer from the interface element to the communication network for transmission to the wireless communications device.

The following is a listing of exemplary data bases that can be used in a present invention method or system. It should be understood that a present invention method or system is not limited to any or all of the databases shown and that other databases are included in the spirit and scope of the claimed invention.

Inventory Database
Inventory ID
Store 1-n
Quantity at store 1-n
Descriptor
Substitute ID 1-n
Substitute discount 1-n
Alternate Pick up discount 1-n

Store Database
Store ID
Store Info
Store contact number
Adjacent Stores 1-n

Customer Database
Customer ID
Customer Personal Info
Customer Billing Info
Customer Cell Phone Info
Loyalty Program Info
Access Privileges 1-n

Order Database (a queue for out of stock orders)
Order ID
Order Information
Date
Customer ID
Store ID
Item ID 1-n
Order Status
Pick Up Preference

Transaction Database (an order turns into a transaction when it is fulfilled)
Transaction ID
Date
Order Information
Customer ID
Store ID
Item ID 1-n
Order Status

Substitute Offers Database (used for making offers in response to item requests)
Item ID
Substitute ID
Offer Descriptor
Offer rules and conditions
Offer discount amount

Thus, it is seen that the objects of the invention are efficiently obtained, although changes and modifications to the invention should be readily apparent to those having ordinary skill in the art, without departing from the spirit or scope of the invention as claimed. Although the invention is described by reference to a specific preferred embodiment, it is clear that variations can be made without departing from the scope or spirit of the invention as claimed.

### FIGURE KEY

102 specially programmed general-purpose computer
104 interface element
106 query element
108 processor
110 query
112 communication network
114. wireless communications device
116 locating element
118 memory element
120 order
122 offer element
124 offer
126 order
130 notification element
132 notification
134 substitution element
136 offer
138 order
140 availability element
142 offer
144 order
146 marketing element
148 offer
150 order
152 incentive
154 order
156 inquiry
158 status report
162 order
164 card reader

What is claimed is:

1. A method for querying an end user, comprising the steps of:
generating, in a processor of a specially programmed general-purpose computer, a first query as to whether an item is out of stock at a first retail location or missing at said first retail location; and,
transmitting said first query from an interface element in said general-purpose computer to a communication network for transmission to a wireless communications device located in said first retail location.

2. The method of claim 1 wherein transmitting said first query further comprises transmitting a request to interface with the general-purpose computer and the method further comprising:
receiving in said interface element a transmission from said communication network including a response to the request to interface;
authorizing, in the processor, continued communication with the wireless communications device through the interface element; and,
transmitting the authorization from the interface element to the communication network for transmission to the wireless communications device.

3. The method of claim 1 further comprising determining, using the interface element and the processor, that the wireless communications device is registered with the first retail location.

4. The method of claim 1 further comprising receiving in said interface element a transmission from said communication network regarding an order for one of an out of stock item or a missing item, said order transmitted from said wireless communications device to said communication network.

5. The method of claim 4 further comprising transmitting a second query from the interface element to the communication network for transmission to the wireless communications device, the second query including an option to authorize payment for said order.

6. The method of claim 4 further comprising:
generating in said processor an offer regarding at least one option for gaining possession of said item;
transmitting said offer from said interface element to said communication network for transmission to said wireless communications device; and,
receiving in said interface element a transmission from said communication network regarding selection of an option from said at least one option, said selection transmitted from said wireless communications device.

7. The method of claim 4 further comprising:
determining with said processor that said order is available at one of a different area of said first retail location, at least one second retail location, different than said first retail location. or via an online or website ordering method;
when the item is available at the at least one second retail location, transmitting a request from the processor through the interface element to the at least one second retail location to hold the item;
generating in said processor a notification regarding said availability at said one of a different area of said retail location or at least one different second retail location; and,
transmitting said notification from said interface element to said communication network for transmission to said wireless communications device.

8. The method of claim 4 further comprising:
generating a notification in said processor regarding availability of said order; and,
transmitting said notification from said interface element to said communication network for transmission to said wireless communications device.

9. The method of claim 4 further comprising:
generating in said processor a substitution offer regarding the order; and,
transmitting said substitution offer from said interface element to said communication network for transmission to said wireless communications device.

10. The method of claim 1 further comprising determining with at least one of said interface element and said processor that said wireless communications device is disposed in said first retail location and wherein transmitting said first query further comprises transmitting in response to said determining that said wireless communications device is disposed in said retail location.

11. The method of claim 1 further comprising
prior to transmitting said first query, receiving, in said interface element, a transmission from the wireless communications device via said communication network requesting connection with the interface element.

12. An apparatus for querying an end user, comprising:
a query element, in a processor of a specially programmed general-purpose computer, arranged to generate a first query as to whether an item is out of stock at a first retail location or missing at said first retail location; and,
an interface element, in said general-purpose computer, arranged to transmit said first query to a communication network for transmission to a wireless communications device located in the first retail location.

13. The apparatus of claim 12 wherein said interface element is arranged to receive a transmission from said communication network regarding an order for at least one of an out of stock item or a missing item, said order transmitted from said wireless communications device to said communication network.

14. The apparatus of claim 13 wherein the query element is arranged to generate a second query regarding an option to authorize payment for the order and the interface element is arranged to transmit said second query to the communication network for transmission to the wireless communications device.

15. The apparatus of claim 13 further comprising an offer element in said processor arranged to generate an offer regarding at least one option for gaining possession of said item and a notification element in said processor arranged to generate a notification regarding availability of said order, wherein said interface element is arranged to transmit said offer and said notification to said communication network for transmission to said wireless communications device.

16. The apparatus of claim 13 further comprising an availability element in said processor arranged to determine that said order is available at a different area of said first retail location, at least one second retail location, different than said first retail location, or via an online or website ordering method and wherein a notification element in the processor is arranged to generate a notification regarding said availability at said one of a different area of said first retail location or a second retail location different than said first retail location and wherein said interface element is arranged to transmit said notification to said communication network for transmission to said wireless communications device.

17. The apparatus of claim 13 further comprising a substitute offer element in said processor, arranged to generate, in response to said interface element receiving a transmission from said communication network regarding the order, a substitution offer for a substitute item and wherein said interface element is arranged to transmit said substitution offer to said communication network for transmission to said wireless communications device.

18. The apparatus of claim 12 further comprising a locating element in said processor arranged to determine whether said wireless communications device is disposed in said retail location and wherein said interface element is arranged to transmit said first query in response to said locating element determining that said wireless communications device is disposed in said retail location.

19. A method for ordering an out of stock item, comprising the steps of:
receiving, in an interface element for a specially programmed general-purpose computer, information displayed in a first retail location regarding an item for sale in the first retail location, the information transmitted from a wireless communications device via a communication network and uploaded to the wireless communications device using a data input function in the wireless communications device; and,
generating an order for the item in a processor of the general-purpose computer.

20. The method of claim 20 further comprising:
generating, in the processor, a query regarding an option to authorize payment for the order and an offer regarding at least one option for gaining possession of the item; and,
transmitting the query and the offer from the interface element to the communication network for transmission to the wireless communications device.

21. The method of claim 19 further comprising:
determining with said processor that said order is available at one of a different area of said first retail location or a second retail location, different than said first retail location;
generating in said processor a notification regarding said availability at said one of a different area of said first retail location or the second retail location; and,
transmitting said notification from said interface element to said communication network for transmission to said wireless communications device.

22. The method of claim 19 further comprising:
generating in said processor, in response to receiving the information displayed in the first retail location regarding an item for sale in the first retail location, a substitution offer regarding a substitute item; and,
transmitting said substitution offer from said interface element to said communication network for transmission to said wireless communications device.

23. An apparatus for ordering an out of stock item, comprising:
an interface element, in a processor of a specially programmed general-purpose computer, arranged to receive a message from a wireless communications device via a wireless communications network regarding information displayed in a first retail location regarding an item for sale in the first retail location, the information obtained using a data input function in a wireless communications device; and,
an ordering element in the processor arranged to generate an order for the item.

24. The apparatus of claim 23 further comprising a query element in the processor arranged to generate a query regarding an option to authorize payment for the order and an offer regarding at least one option for gaining possession of the item and wherein the interface element is arranged to transmit the query to the communication network for transmission to the wireless communications device.

25. The apparatus of claim 23 further comprising:
an availability element in the processor arranged to determine that said order is available at one of a different area of said first retail location or a second retail location, different than said first retail location; and,
a notification element in the processor arranged to generate a notification regarding said availability at said one of a different area of said first retail location or the second retail location; and, wherein the interface element is arranged to transmit said notification to said communication network for transmission to said wireless communications device.
